(19) United States
(12) Patent Application Publication
(10) Pub. No.: US 2006/0278767 A1
(43) Pub. Date: Dec. 14, 2006

(54) Accessory tray for a ladder

(76) Inventor: Raymond J. Martineau, Washago (CA)

Correspondence Address: WOLFF & SAMSON, P.C., ONE BOLAND DRIVE, WEST ORANGE, NJ, 07052, US

(21) Appl. No.: 11/141,378

(22) Filed: May 31, 2005

(51) Int. Cl. B05B 15/06

(52) U.S. Cl. 248/77

(57) ABSTRACT

An accessory tray having a tube secured on its underside and extending from the side thereof, and a stabilizer under the front end of the tray, such that when the tube is positioned in the end of a ladder rung, the stabilizer can be secured to the side of the ladder to hold the tray level.

### BACKGROUND OF THE INVENTION

When using a ladder for cleaning, painting, or repairing a structure which is out of reach from the ground, it is usually necessary to have a means for holding items such as tools etc. at the level on the ladder wherein the work is taking place. These items are usually somehow hung upon various rungs of the ladder or are carried up the ladder for use and taken down the ladder when not in use. There is therefore a need for an item which can be easily and solidly attached to a ladder at a required height and can be removed just as easily when not required.

### SUMMARY OF THE INVENTION

This invention consists generally of a tray having a tube secured on its underside and extending from one side of the tray. The tube can slide into a rung of the ladder so positioning the tray at any height on the ladder. A stabilizer bar is situated at the front end of the tray and underneath the tray and can be secured by its lower end to one side of the ladder by a screw clamp to hold the tray in a level orientation.

### BRIEF DESCRIPTION OF THE DRAWINGS

A preferred embodiment of the invention will now be described with reference to the accompanying drawings in which:

FIG. 1 is a side elevational view of the tray of this invention in position upon a ladder which itself is between the ground and a wall.

FIG. 2 is a front elevational view of the region shown within the circle A in FIG. 1.

FIG. 3 is an enlarged side elevational view of the region shown within the circle A in FIG. 1, and

FIG. 4 is a plan view looking in the direction B in FIG. 2.

### DETAILED DESCRIPTION OF THE INVENTION

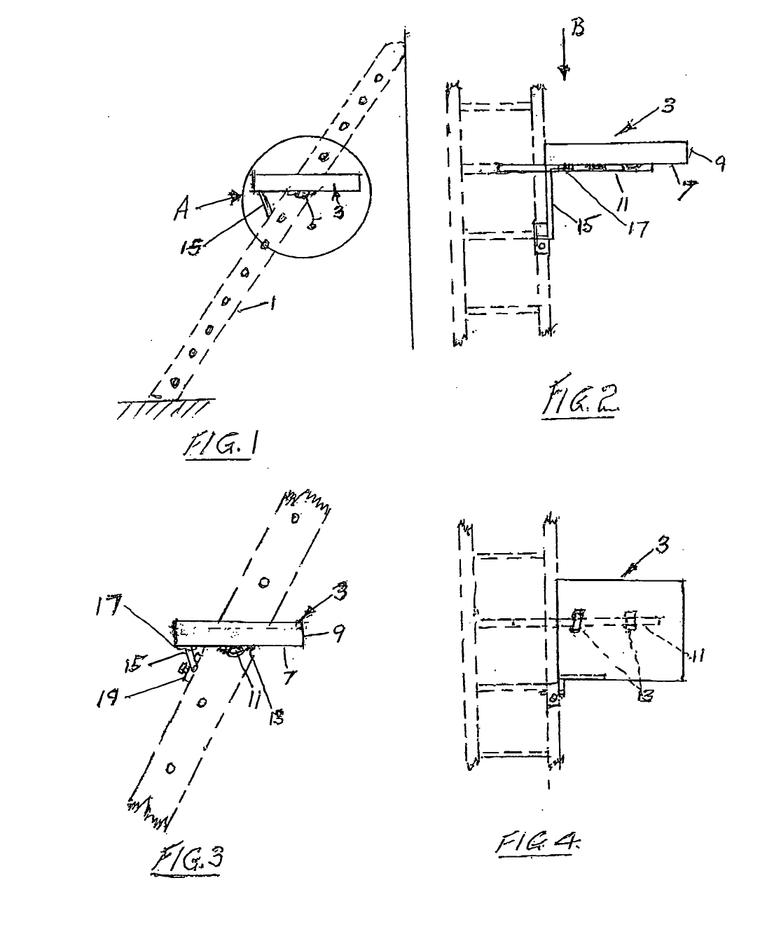

Referring specifically to the drawings, in FIG. 1 there is shown, in broken lines, a ladder 1 extending between the ground and a wall. A tray 3 made from wood, metal or plastic extends at one side of the ladder and is supported by a tube 5 which slides into the end of a rung of the ladder. A stabilizer 15 extends below the front of the tray and is secured to one side of the ladder 1.

Referring specifically to FIGS. 2, 3 and 4, tray 3 consists of a base 7 and four sides 9. A tube 11 is secured to the base 7 of the tray by fasteners such as clamps 13 which are secured to the base 7 by screws, bolts or other similar type of securing means (not shown). A stabilizer 15 extends from below the front of box 3 to the side of ladder 1. The stabilizer 15 is approximately “Z”-shaped and is secured to base 7 by means of suitable clamps 17 which are screwed or otherwise attached to base 7. The stabilizer 15 is secured to the upper edge of the side of the ladder by means of a screw clamp 19. The stabilizer 15 can therefore be adjusted by moving screw clamp 19 so that the tray 7 can be held in a horizontal position no matter what the angle of the ladder is.

Although only one tray 3 has been shown attached to one side of the ladder, it is to be understood that a similar tray could also be attached to the other side of the ladder either at the same or a different height so allowing a person to work at different heights of the ladder. Also two trays will permit the use of a larger temporary storage area for use when working up the ladder.

It will thus be seen that an invention has been disclosed which greatly facilitates working up a ladder as it is not necessary when using this invention to continue to climb up and down a ladder to lift and lower necessary items.

While the invention has been described with reference to specific embodiments, modifications and variations of the invention may be constructed without departing from the scope of the invention, which is defined in the following claims.

What is claimed is:

1. An accessory tray for use with a ladder, comprising:
a base;
four sides;
a tube secured to the base and extending past one of the sides;
and a stabilizer extending below one edge of the base from a position in which, when the lower end of the stabilizer is secured to the side of a ladder it will prevent rotation of said tray about the longitudinal axis of the tube, when said tube is inserted into a rung of the ladder.

2. The tray of claim 1 wherein said tube is secured to the base of said tray by clamps which are secured to the underside of said base by fasteners.

3. The accessory tray of claim 1 wherein said stabilizer is secured to the base of the tray by clamps which are secured by fasteners to the underside of the base and the free end of said stabilizer is secured to the side of a ladder by a screw clamp.
